(19) United States
(12) Patent Application Publication
(10) Pub. No.: US 2017/0357924 A1
(43) Pub. Date: Dec. 14, 2017

(54) WORKER-MANAGEMENT SYSTEMS

(71) Applicant: BRAYDON SCOTT MACKENZIE GOUGH, GRIMSHAW (CA)

(72) Inventor: BRAYDON SCOTT MACKENZIE GOUGH, GRIMSHAW (CA)

(21) Appl. No.: 15/178,007

(22) Filed: Jun. 9, 2016

(51) Int. Cl. G06Q 10/06

(52) U.S. Cl. CPC G06Q 10/06311; G06Q 10/06314

(57) ABSTRACT

A worker-management system having a computer-application, with the computer-application including a profile-module, a safety-ticket-module, a certification-module, an information-module, a notifications-module, and a calendar-module, all in functional combination. The computer-application includes multiple profiles and accesses such that the employee-user may store information related to multiple employers; and the employer-user may store information related to multiple employees. The worker-management system is useful for providing a computer-assisted application which provides storage, tracking and management of information such that the information which is generally issued and maintained via hardcopy (e.g., ID card, paper-copy, etc.) is maintained on/in a computer-operable medium to conserve resources as a tangible output. The worker-management system may further include digital-video-storage capabilities such that the user (employee-user and/or employer-user) is able to upload and download digital-videos.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of computer applications and more specifically relates to worker-management systems and methods.

### 2. DESCRIPTION OF RELATED ART

In many industries, workers are required to have specific certifications or accreditations in order to perform, or be eligible to perform certain work related tasks. Some such tasks include safety procedures, various equipment certifications, fire related training, and/or other similar tasks. These types of certifications and/or accreditations often expire or may require recertification. Further, worker contact information, such as emergency contact or supervisor information must be kept up accurate and up-to-date.

Most conventional certifications are currently issued via a hardcopy certificate, badge or other similar means. These hardcopies may include paper certificates, plastic credentials, and/or badges which may be difficult to maintain and carry when a worker has multiple certifications and accreditations that are to be recertified, maintained, and updated. Additionally, hardcopies are prone to being lost or damaged and cannot be remotely available to view the current status of the certification by an individual who is not in possession of the hardcopy. Available are some applications to maintain employee records, however no such application(s) include the compiling of worker certifications. Therefore a suitable solution is desired.

Several attempts have been made to solve the above-mentioned problems such as those found in U.S. and Foreign Pat. and Pub. Nos. US2010/0211515 Woodings et al.; US2002/0052773 to Kramer et al.; US2002/0046112 to Nitta et al.; US2013/0139065 to Spinks; US2014/0249877 to Hull et al.; U.S. Pat. No. 8,321,254 to Bernasconi et al.; U.S. Pat. No. 5,111,391 to Fields et al.; and WO2002/010989 to Stern et al. This art is representative of computer applications. However, none of the above inventions and patents, taken either singly or in combination, is seen to describe the invention as claimed.

Preferably, a worker-management system and method should provide a convenient and reliable application which compiles worker data related to contact information, accreditations, and certifications and, yet would operate reliably and be administered at a modest expense. Thus, a need exists for reliable worker-management systems and methods to avoid the above-mentioned problems.

### BRIEF SUMMARY OF THE INVENTION

In view of the foregoing disadvantages inherent in the known computer applications art, the present invention provides novel worker-management systems and methods. The general purpose of the present invention, which will be described subsequently in greater detail is to provide an application which provides the user with a plurality of modules to compile, store, and manage accreditations, certifications, and contact information for a plurality of workers.

A worker-management system is disclosed herein, in a preferred embodiment, comprising a computer-application; with the computer-application comprising a profile-module, a safety-ticket-module, a certification-module, an information-module, a notifications-module, and a calendar-module, all in functional combination. The computer-application preferably includes multiple profiles and accesses such that the employee-user may store information related to multiple employers; and the employer-user may store information related to multiple employees.

The worker-management system is useful for providing a computer-assisted application which provides storage, tracking and management of information such that the information which is generally issued and maintained via hardcopy (e.g., ID card, paper-copy, etc.) and maintained on/in a computer-operable medium to conserve resources as a tangible output. The preferred embodiment of the worker-management system further includes digital-video-storage capabilities such that the user (employee-user and/or employer-user) is able to upload and download digital-videos.

Upon completion of downloading and viewing a digital-video, the worker-management system may provide the employee-user with a completion ticket related to the digital-video, in the preferred embodiment. The worker-management system may be configured to specify which particular digital-video are applicable to a particular employee-user and may also provide the employee-user with information related to certificates or completion tickets which may be issued upon complete viewing of the digital-video the in preferred embodiment.

Preferably, the profile-module, the certification-module, the information-module, the notifications-module, and the calendar-module are all viewable and updateable by an employee-user. Additionally, the profile-module, the certification-module, the information-module, the notifications-module, and the calendar-module are viewable and updateable by an employer-user. Preferably, the profile-module maintains employee-profile information. Such information may include, but not be limited to: emergency contact information, status information, photograph, and prior work history.

Calendar-module may also be viewable and alterable by a third-party, such that the third-party may post important dates to the calendar-module. The calendar-module may also include directed-advertisements based on events posted on the calendar-module and the specific region in which the employee-user is located. Preferably, events maintained by calendar-module include only the events related to a current employer-user.

The safety-ticket-module preferably maintains information related to current-safety-tickets, expired-safety-tickets, pending-safety-tickets, and provides notifications to the employee and/or the employer when a safety-ticket becomes expired. Preferably, the safety-ticket-module further includes matrix-barcode-reading-capabilities such that the employee may renew his/her expired safety tickets via scanning a matrix-barcode related to a safety-ticket. The certification-module preferably maintains information related to current-certifications, expired-certifications, and pending-certifications and the information-module preferably maintains miscellaneous information inputted by the user(s) and includes photo-storage capabilities such that the user(s) may store photographic copies of documents with the worker-management system. The notifications-module maintains and provides notifications to the user(s). Such notifications preferably include notifications when an employer-employee relationship is created, when information contained by the worker-management system is altered by the employee-user, and when information contained by the worker-management system is altered by the employer-user.

The calendar-module preferably maintains important dates which are imputed by the one or more users. The profile-module, the certification-module, the information-module, the notifications-module, and the calendar-module are viewable are all updateable by the user(s) via Smartphone, desktop-computer, a tablet-computer, or other similar device (in the preferred embodiment).

Also disclosed herein, in a preferred embodiment, is a method of using a worker-management system; comprising the steps of: providing a worker-management system (comprising a computer-application), inputting information into one or more modules of the computer-application, receiving alerts from the computer-application related to the information inputted into the one or more modules of the computer-application, accessing the information from the computer-application, and altering the information inputted into the computer-application.

The present invention holds significant improvements and serves as a worker-management system and method. For purposes of summarizing the invention, certain aspects, advantages, and novel features of the invention have been described herein. It is understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, worker-management systems and methods, constructed and operative according to the teachings of the present invention.

FIG. 1 shows a perspective view illustrating a user during an ‘in-use’ condition showing the worker accessing the worker-management systems and methods via a mobile phone according to an embodiment of the present invention.

FIG. 2 is a schematic diagram illustrating a diagram of a worker-management system comprising a computer-application according to an embodiment of the present invention of FIG. 1.

FIG. 3 illustrates ‘screenshots’ of the worker-management system operable upon a mobile phone according to an embodiment of the present invention of FIGS. 1-2.

FIG. 4 illustrates ‘screenshots’ of the worker-management system operable upon a desktop computer according to an embodiment of the present invention of FIGS. 1-3.

FIG. 5 is a flowchart illustrating a method of use for the worker-management system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to computer applications and more particularly to worker-management systems and methods as used to improve the availability, ease of use and the compilation and reduction of hard-copies of worker information.

Generally speaking, the worker-management system comprises a computer-application, with the a computer-application comprising: a profile-module, a safety-ticket-module, a certification-module, an information-module, a notifications-module, a calendar-module.

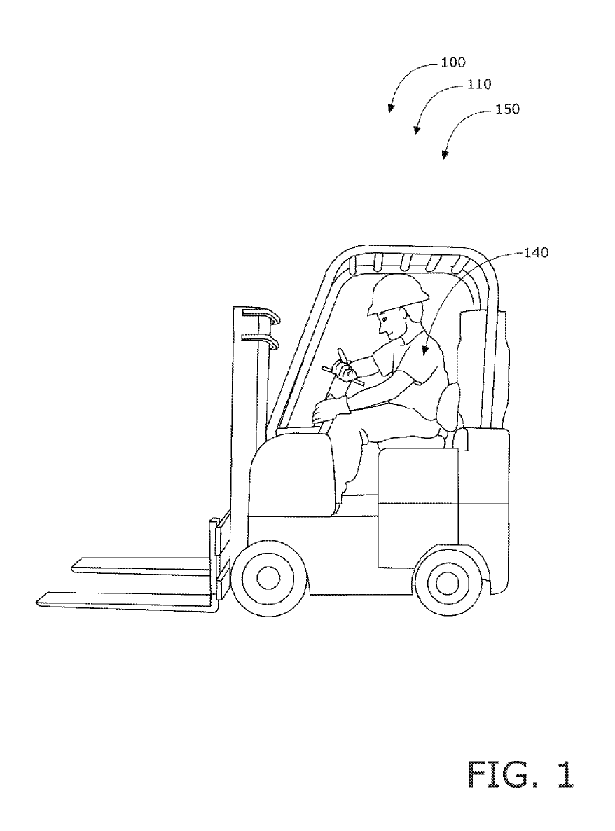

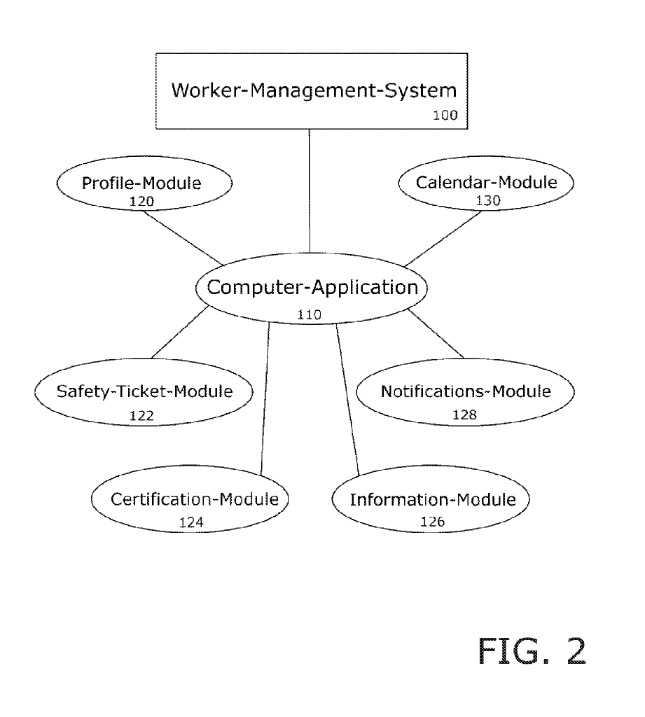

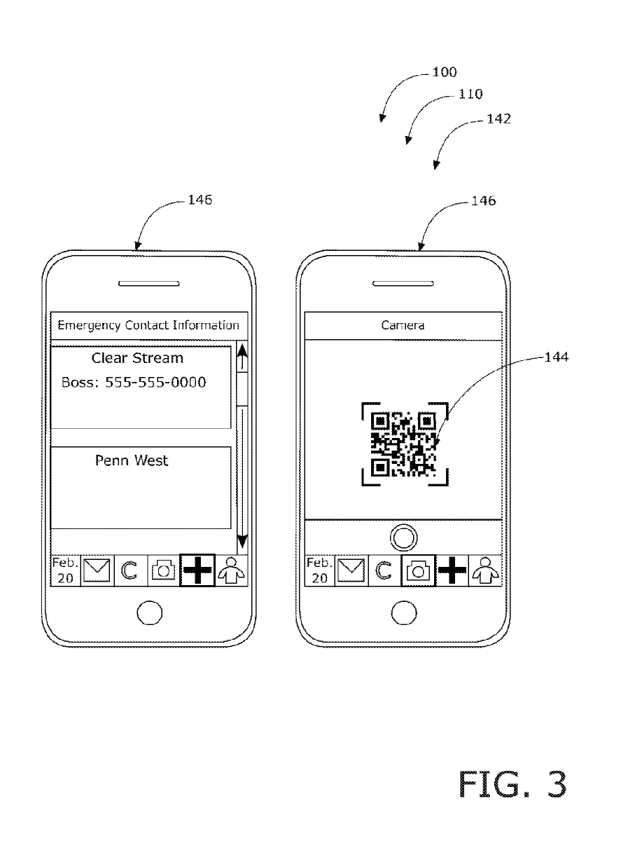

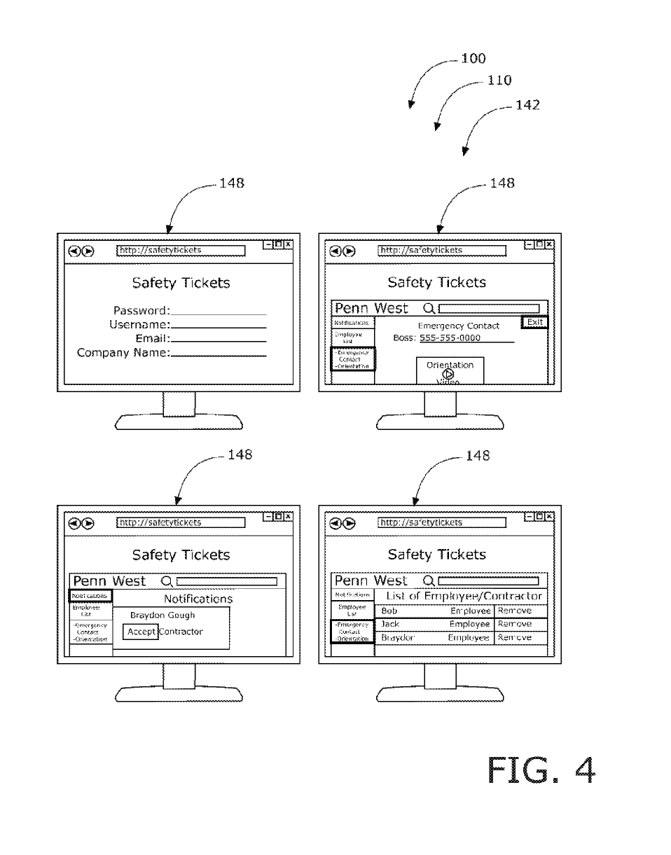

Referring to the drawings by numerals of reference there is shown in FIGS. 1-4, worker-management system 100 comprising computer-application 110 comprising profile-module 120, safety-ticket-module 122, certification-module 124, information-module 126, notifications-module 128, and calendar-module 130, in functional combination.

Notifications-module 128 may provide the employee-user 140 with notifications when an employer-employee relationship is created. Additionally, worker-management system 100 may include notifications-module 128, which may provide a notification to the employer-user when information contained by worker-management system 100 is altered by the employee-user 140. Also, notifications-module 128 may also provide a notification to the employee-user 140 when information contained by the worker-management system 100 is altered by the employer-user.

Profile-module 120 may maintain employee-profile information, and safety-ticket-module 122 may maintain information related to current-safety-tickets, expired-safety-tickets, and/or pending-safety-tickets. Certification-module 124 may maintain information related to current-certifications, expired-certifications, and/or pending-certifications. Safety-ticket-module 122 may also provide notifications to the employee and the employer when a safety-ticket becomes expired. Safety-ticket-module 120 may additionally include matrix-barcode-reading-capabilities (e.g., QR-code reader) such that the employee may renew his or her expired safety tickets via scanning a matrix-barcode 144 related to a safety-ticket.

Information-module 126 may maintain miscellaneous information inputted by a user, notifications-module 128 may maintain and provide notifications to user and calendar-module 130 may maintain important dates.

Worker-management system 100 is useful for providing computer-assisted application 110 which may provide storage, tracking and management of information such that the information which is generally issued and maintained via hardcopy (e.g., paper certificates, plastic badges, etc.) is maintained in a computer-operable medium 142 to conserve resources as a tangible output. Worker-management system 100 may include profile-module 120, certification-module 124, information-module, 126 notifications-module 128, and calendar-module 130 may be viewable and updateable by an employee-user 140, and additionally viewable and updateable by an employer-user.

Profile-module 120, certification-module 124, information-module 126, notifications-module 128, and calendar-module 130 may be viewable and updateable by user via Smartphone 146. Also, profile-module 120, certification-module 124, information-module 126, notifications-module 128, and calendar-module 130 may be viewable and updateable by a user via desktop-computer 148 or tablet-computer. Information-module 126 of worker-management system 100 may further include photo-storage capabilities such that user may store photographic copies of documents with worker-management system 100.

Worker-management system 100 may also include computer-application 110 which includes multiple profiles, such that the employer-user may store information related to multiple employees. Also, computer-application 110 may also include multiple profiles, such that the employee-user 140 may store information related to multiple employers. Worker-management system 100 may further include digital-video-storage capabilities, such that user is able to upload and download digital-videos. Worker-management system 100 may include an employee which is employed by the employer-user, or may additionally or alternately include an employee who is employed as an independent-contractor performing work for the employer-user.

Upon completion of downloading and viewing a digital-video, worker-management system 100 may provide employee-user 140 with a completion ticket related to the digital-video. Worker-management system 100 may also be configured to specify which particular digital-video are applicable to a specific employee-user 140 and may also provide employee-user 140 with information related to certificates and/or completion tickets which may be issued upon complete viewing of the digital-video.

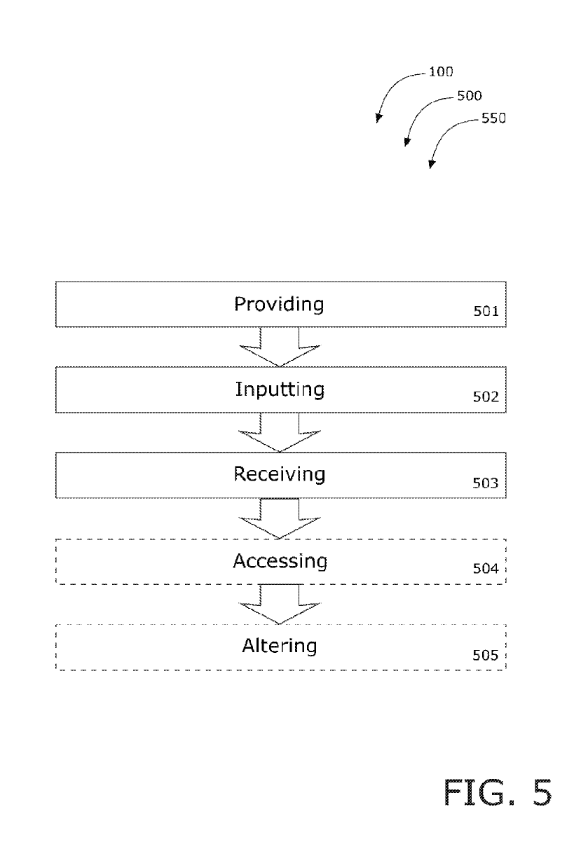

Referring now to FIG. 5 showing flowchart 550 illustrating method of use 500 for worker-management system 100 according to an embodiment of the present invention of FIGS. 1-4.

As shown, method of use 500 may comprise the steps of: step one 501, providing worker-management system comprising computer-application 110; step two 502, inputting information into one or more modules of computer-application 110; step three 503, receiving alerts from computer-application 110 related to the information inputted into the one or more modules of computer-application 110; step four 504, accessing the information from computer-application 110; and step five 505, altering information inputted into computer-application 110.

It should be noted that step four 504 and step five 505 are optional steps and might not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112(f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A worker-management system comprising a computer-application including
a profile-module,
a safety-ticket-module,
a certification-module,
an information-module,
a notifications-module, and
a calendar-module;
wherein said computer-application comprises said profile-module, said safety-ticket-module, said certification-module, said information-module, said notifications-module, and said calendar-module in functional combination;
wherein said profile-module is configured to maintain employee-profile information;
wherein said safety-ticket-module is configured to maintain information related to current-safety-tickets, expired-safety-tickets, and pending-safety-tickets;
wherein said certification-module is configured to maintain information related to current-certifications, expired-certifications, and pending-certifications;
wherein said information-module is configured to maintain miscellaneous information inputted by a user,
wherein said notifications-module is configured to maintain and provide notifications to said user;
wherein said calendar-module is configured to maintain important dates; and
wherein said worker-management system is is configured to provide the computer-assisted application, which is configured to provide storage, tracking and management of information such that said information, which is generally issued and maintained via hardcopy, is maintained in a computer-operable medium.

2. The worker-management system of claim 1, wherein said profile-module, said certification-module, said information-module, said notifications-module, and said calendar-module are viewable and updateable by an employee-user.

3. The worker-management system of claim 2, wherein said profile-module, said certification-module, said information-module, said notifications-module, and said calendar-module are viewable and updateable by an employer-user.

4. The worker-management system of claim 2, wherein said safety-ticket-module is further configured to provide a notification to said employee and said employer when a safety-ticket becomes expired.

5. The worker-management system of claim 1, wherein said safety-ticket-module includes matrix-barcode-reading-capabilities configured such that said user may renew expired safety tickets via scanning a matrix-barcode related to a safety-ticket.

6. The worker-management system of claim 1, wherein said profile-module, said certification-module, said information-module, said notifications-module, and said calendar-module are viewable and updateable by said user via a Smartphone.

7. The worker-management system of claim 1, wherein said profile-module, said certification-module, said information-module, said notifications-module, and said calendar-module are viewable and updateable by the user via a desktop-computer.

8. The worker-management system of claim 1, wherein said profile-module, said certification-module, said information-module, said notifications-module, and said calendar-module are viewable and updateable by the user via a tablet-computer.

9. The worker-management system of claim 1, wherein said information-module includes photo-storage capabilities configured such that said user can store photographic copies of documents with said worker-management system.

10. The worker-management system of claim 1, wherein said notifications-module is further configured to provide an employee-user with notifications when an employer-employee relationship is created.

11. The worker-management system of claim 3, wherein said notifications-module is further configured to provide a notification to said employer-user when information contained by said worker-management system is altered by said employee-user.

12. The worker-management system of claim 3, wherein said notifications-module is further configured to provide a notification to said employee-user when information contained by said worker-management system is altered by said employer-user.

13. The worker-management system of claim 3, wherein said computer-application is further configured to include multiple profiles such that said employee-user can store information related to multiple employers.

14. The worker-management system of claim 3, wherein said computer-application is further configured to include multiple profiles such that said employer-user can store information related to multiple employees.

15. The worker-management system of claim 1, further comprising digital-video-storage capabilities configured such that the user is able to upload and download digital-videos.

16. The worker-management system of claim 1, wherein said employee is employed by said employer-user.

17. The worker-management system of claim 3, wherein said employee-user is employed as an independent-contractor of said employer-user.

18. A worker-management system comprising a computer-application including
a profile-module,
a safety-ticket-module,
a certification-module,
an information-module,
a notifications-module, and
a calendar-module;
wherein said computer-application comprises said profile-module, said safety-ticket-module, said certification-module, said information-module, said notifications-module, and said calendar-module in functional combination;
wherein said profile-module is configured to maintain employee-profile information;
wherein said safety-ticket-module is configured to maintain information related to current-safety-tickets, expired-safety-tickets, and pending-safety-tickets;
wherein said certification-module is configured to maintain information related to current-certifications, expired-certifications, and pending-certifications;
wherein said information-module is configured to maintain miscellaneous information inputted by a user;
wherein said notifications-module is configured to maintain and provide notifications to said user;
wherein said calendar-module is configured to maintain important dates;
wherein said worker-management system is is configured to provide the computer-assisted application, which is configured to provide storage, tracking and management of information such that said information, which is generally issued and maintained via hardcopy, is maintained in a computer-operable medium;
wherein said profile-module, said certification-module, said information-module, said notifications-module, and said calendar-module are viewable and updateable by an employee-user,
wherein said profile-module, said certification-module, said information-module, said notifications-module, and said calendar-module are viewable and updateable by an employer-user,
wherein said safety-ticket-module is configured to provide a notification to said employee and said employer when a safety-ticket becomes expired;
wherein said safety-ticket-module includes matrix-barcode-reading-capabilities configured such that said user may renew expired safety tickets via scanning said a matrix-barcode related to a safety-ticket;
wherein said profile-module, said certification-module, said information-module, said notifications-module, and said calendar-module are viewable and updateable by said user via at least one of a Smartphone, a desktop-computer, and a tablet-computer;
wherein said information-module includes photo-storage capabilities configured such that said user can store photographic copies of documents with said worker-management system;
wherein said notifications-module is further configured to provide said employee-user with notifications when an employer-employee relationship is created;
wherein said notifications-module is further configured to provide notifications to said employer-user when information contained by said worker-management system is altered by said employee-user;
wherein said notifications-module is further configured to provide notifications to said employee-user when information contained by said worker-management system is altered by said employer-user, wherein said computer-application further includes multiple profiles configured such that said employee-user can store information related to multiple employers;
wherein said computer-application further includes multiple profiles configured such that said employer-user can store information related to multiple employees; and
wherein said worker-management system further comprises digital-video-storage capabilities configured such that the user is able to upload and download digital-videos.

19. A method of using a worker-management system comprising the steps of:
providing a worker-management system comprising a computer-application;
inputting information into one or more modules of said computer-application; and
receiving alerts from said computer-application related to said information inputted into said one or more modules of said computer-application.

20. The method of claim 19, further comprising the steps of:
accessing said information from said computer-application; and
altering said information inputted into said computer-application.
